(19) United States
(12) Patent Application Publication
(10) Pub. No.: US 2026/0142923 A1
(43) Pub. Date: May 21, 2026

(54) METHODS, ARCHITECTURES, APPARATUSES AND SYSTEMS FOR USER PLANE TRAFFIC GATING BASED ON ENERGY COST

(71) Applicant: InterDigital Patent Holdings, Inc., Wilmington, DE (US)

(72) Inventors: Achref METHENNI, Montreal (CA); Michael Starsinic, Newtown, PA (US); Saad Ahmad, Montreal (CA); Samir Ferdi, Kirkland (CA); Ulises Olvera-Hernandez, Saint-Lazare (CA)

(21) Appl. No.: 18/950,454

(22) Filed: Nov. 18, 2024

(51) Int. Cl. H04L 47/20; H04L 12/14

(52) U.S. Cl. CPC H04L 47/20; H04L 12/1407

(57) ABSTRACT

Procedures, methods, architectures, apparatuses, systems, devices, and computer program products for user plane traffic gating based on energy cost. A policy control function, PCF, may be configured with information related to energy cost criteria or strategy. The PCF may be triggered, using the information, to obtain energy cost information from the network, e.g., from an energy efficiency control function, EECF. The PCF may use the energy cost measurement/information obtained from the EECF, and the energy cost criteria or strategy information to determine whether and which service flows need to be blocked. The PCF may include this information in one or more policy and charging control, PCC, rules that correspond to the service flows of interest, and may provide this information to a session management function, SMF, to further send corresponding one or more N4 rules to the user plane function, UPF.

### INCORPORATION BY REFERENCE

The following documents are incorporated by reference in their entirety: 3rd Generation Partnership Project (3GPP) TR 23.700-66, “Study on Energy Efficiency and Energy Saving”, Release 19, V 19.0.0 (2024 September); 3GPP TS 23.501, “System architecture for the 5G System (5GS), Stage 2”, V 19.1.0 (2024 September); 3GPP TS 23.502, “Procedures for the 5G System (5GS), Stage 2”, V 19.1.0 (2024 September); 3GPP TS 23.503, “Policy and charging control framework for the 5G System (5GS); Stage 2 (2024 September)”, V19.1.0.

### BACKGROUND

The present disclosure is generally directed to the fields of communications, software and encoding, including, for example, to methods, architectures, apparatuses, systems related to user plane traffic gating.

### SUMMARY

There are disclosed embodiments of methods, as described in the following and as claimed in the appended claims.

There are disclosed embodiments of a device, as described in the following and as claimed in the appended claims.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates that a PCF is provided with energy cost criteria, subscribes to energy cost estimates from an energy efficiency control function (EECF) and determines gating status/parameters for application traffic flows;

FIG. 3 illustrates a WTRU requesting a protocol/packet data unit (PDU) session with energy criteria, and the PCF configures the PDU session with traffic gating information; and

FIG. 4 is a method for user plane traffic gating based on energy cost according to an embodiment.

### DETAILED DESCRIPTION

### Abbreviations and Acronyms

5GS 5G System
5QI 5G QoS Identifier
AF Application Function
ARP Allocation and Retention Priority
AS Application Server
DL Downlink
DNN Data Network Name
EECF Energy Efficiency Control Function
ID Identifier
IP Internet Protocol
NAS Non-Access Stratum
NEF Network Exposure Function
NF Network Function
NWDAF Network Data Analytics Function
PCC Policy and Charging Control
PCF Policy Control Function
PDR Packet Detection Rule
PDU Packet or Protocol Data Unit
QER QoS Enforcement Rule
QFI QoS Flow Identifier
RAN Radio Access Network
QoS Quality of Service
SMF Session Management Function
S-NSSAI Single Network Slice Selection Assistance Information
UE User Equipment
UL Uplink
UPF User Plane Function

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

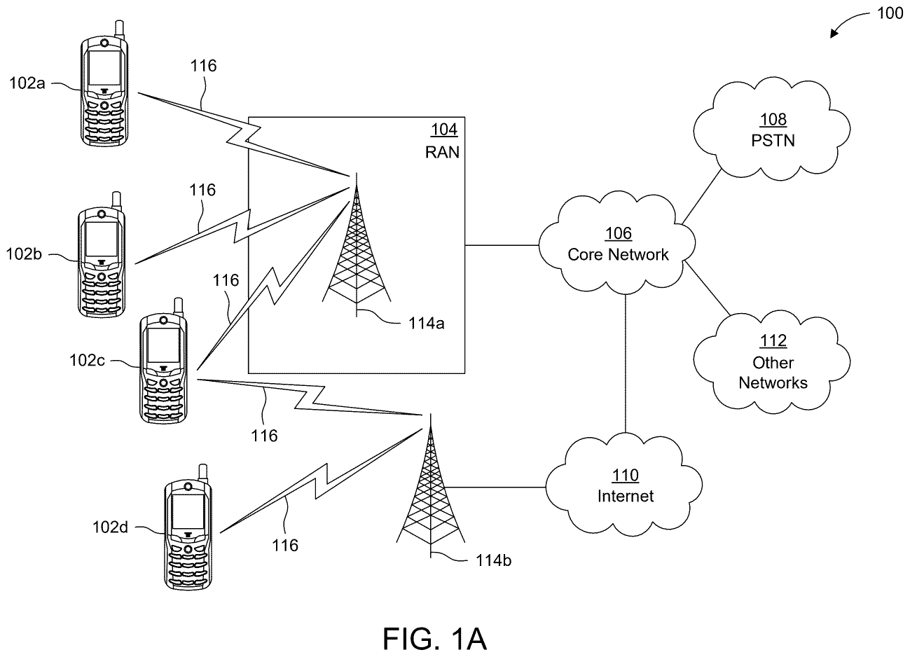

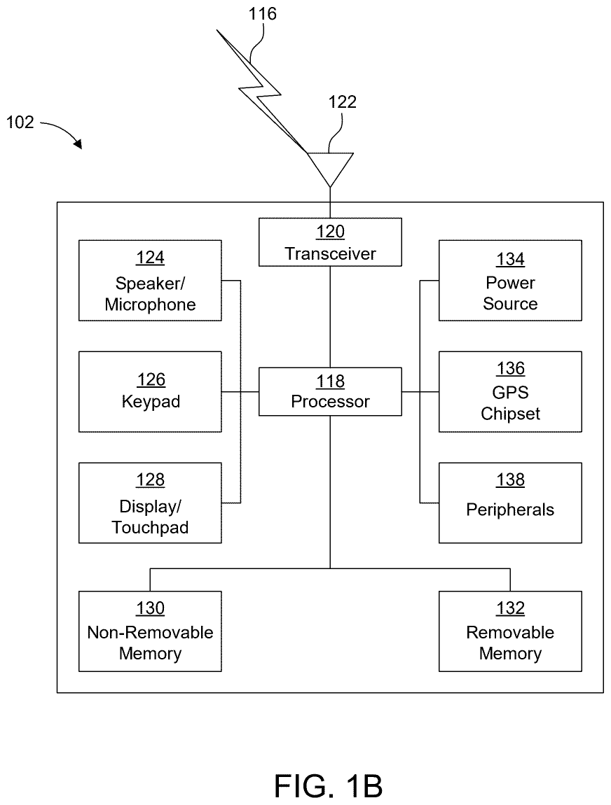

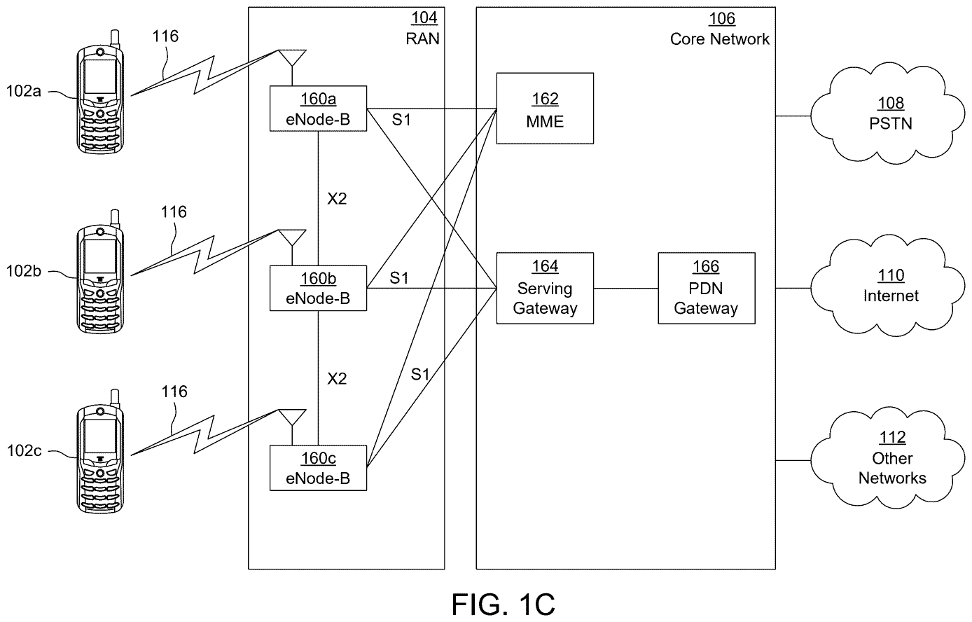

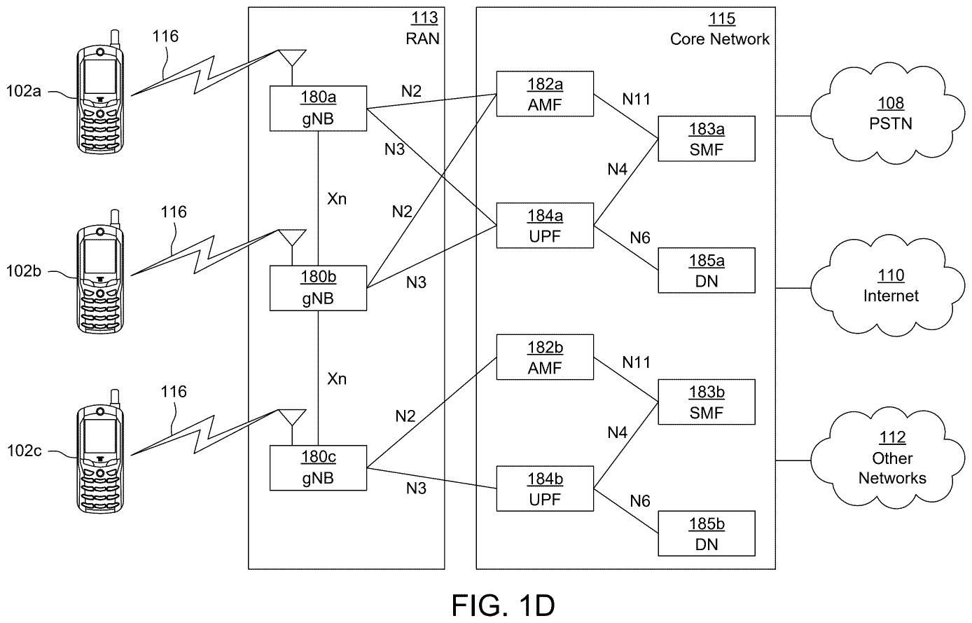

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114 a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114 a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114 b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180 c while also communicating with/connecting to another RAN such as eNode-Bs 160a, 160b, 160c. For example, WTRUs 102 a, 102 b, 102 c may implement DC principles to communicate with one or more gNBs 180 a, 180 b, 180 c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The term “(traffic) gating” or “(traffic) gating control” within the context of the present document stands for the action of “allowing”, “permitting” or “not allowing”, “blocking”, “not permitting” e.g., of traffic (e.g., of data traffic) as in analogy with opening or closing a physical gate. A “gate” may therefore be/may have the status of “closed”, “off” or “on”, “open”. The term “gated off” may be used to indicate that traffic is blocked, not allowed or dropped, while non-gated-off traffic may be non-blocked, allowed or not dropped; e.g., when the UPF determines that a PDU is related to a traffic flow that is gated off, the UPF will discard (i.e. not transmit) the PDU.

PCC Rules and Gate Status

In a 5GS, a WTRU or an AF may request that certain traffic flows need to be treated with certain QoS requirements. For example, an AF may provide traffic flow description to the PCF, either directly if the AF is a trusted entity, or via the NEF. The AF may provide QoS requirements for the traffic flows of interest.

Once the PCF receives and authorizes the AF request, the PCF generates PCC rules for the traffic flow of interest. The PCC rules include traffic description information to allow the dentification of the traffic flow. The PCC rules also include QoS parameters and characteristics for the QoS flow that would carry the traffic flow in the 5GS. For example, the PCC rules include a 5QI, values for the authorized DL/UL guaranteed bitrate for the service data flow, the authorized DL/UL maximum bitrate for the service data flow, an ARP value, a priority level value, and so on.

The PCC rules also include a gate status field, which indicates whether the service data flow, corresponding to the service data flow template in the PCC rule, may pass (where the Gate is open), or needs to be discarded (Gate is closed). This parameter may be used by the UPF to determine whether to discard, or potentially let pass, traffic flows of interest.

An application server may be exchanging data traffic with a WTRU via the 5GS.

When the 5GS is energy aware, for example, if an energy consumption based charging mechanism is used by the 5GS, for the WTRU user plane data usage, or between the 5GS and the Application service provider, the AF or the WTRU may decide or prefer that certain traffic that has certain energy cost values may need to be blocked from being forwarded to the WTRU or AS in the 5GS.

It is challenging for gating control that is configured by the PCF to the UPF to take in consideration energy cost related to traffic of interest.

### A PCF Determines to Configure Traffic Gating Based on Energy Cost Information

A PCF may be configured with information related to energy cost criteria or strategy. The PCF may be triggered, using this information, to obtain energy cost information from the network, e.g., the EECF. The PCF may use the energy cost measurement/information obtained from the EECF, and the energy cost criteria or strategy information to determine whether and which service flows need to be blocked or gated off. The PCF may include this information in the PCC rules that correspond to the service flows of interest, and may provide this information to the SMF, to further send corresponding N4 rules to the UPF, and so on.

### PCF

A PCF may perform the following actions.

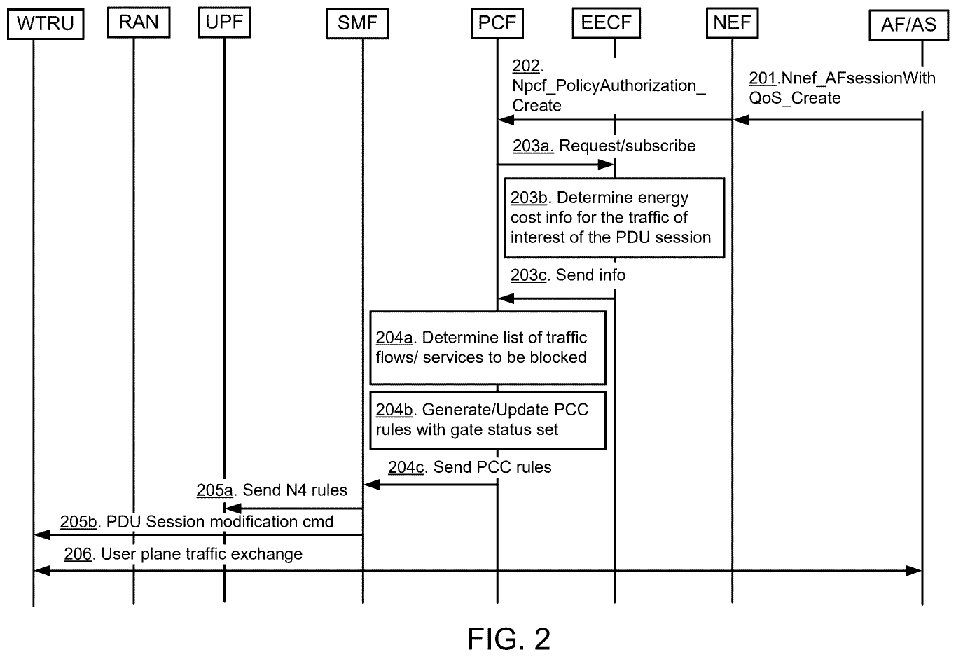

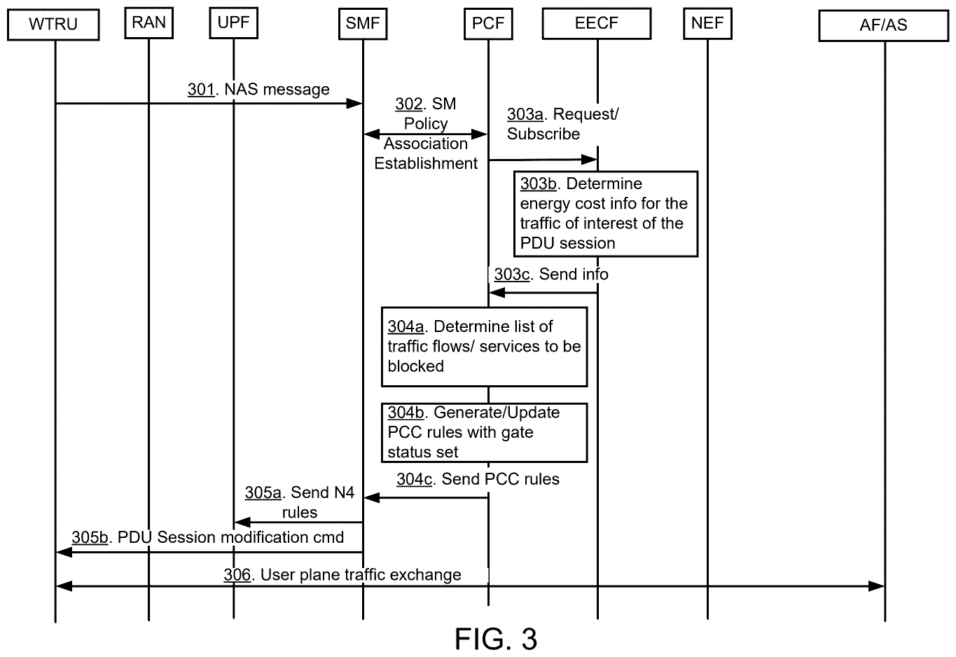

First (section “AF Configures the PCF with Energy Cost Criteria and PCF Determines Selective Gating Off/Blocking of Certain Service Description” and FIG. 2, steps 201-202, section “WTRU Configures the PCF with Energy Cost Criteria and PCF Determines Selective Gating Off/Blocking of Certain Service Description” and FIG. 3), the PCF may receive a request message. The request message may include any of:
a service description. The service description may describe a traffic flow and be an IP 4-tuple or the service description may indicate a type of traffic flow (e.g., web browsing);
an indication that the energy that is associated with the service should not exceed an indicated level. The request message may include a PDU Session ID; and
a WTRU identifier and a DNN/S-NSSAI that may be used by the PCF to determine a PDU Session ID.

The message may be received from the WTRU via NAS Messaging and the SMF. When the message is received from the WTRU, the message may include the PDU Session ID.

The message may be received from an AF. When the message is received from an AF, message may include a WTRU Identifier and a DNN/S-NSSAI that may be used by the PCF to determine a PDU Session ID.

Second (section “AF Configures the PCF with Energy Cost Criteria and PCF Determines Selective Gating Off/Blocking of Certain Service Description” and FIG. 2, step 203a) the PCF may send a subscription request message to the EECF. The subscription request message may indicate the PDU Session ID, the indicated level, and the service description.

Third (“AF Configures the PCF with Energy Cost Criteria and PCF Determines Selective Gating Off/Blocking of Certain Service Description” and FIG. 2, step 203c) the PCF may receive a notification from the EECF that indicates that the traffic in the PDU Session that is associated with the service description has exceeded the level.

Fourth (“AF Configures the PCF with Energy Cost Criteria and PCF Determines Selective Gating Off/Blocking of Certain Service Description” and FIG. 2, steps 204a-204c) the PCF may determine, based on the notification, PCC Rules to send to the SMF that serves the PDU Session. The PCC Rules may indicate to the SMF that traffic that is associated with the service description should be gated off. The PCC rules may also include parameters related to the gating (e.g. traffic blocking duration).

AF Configures the PCF With Energy Cost Criteria and PCF Determines Selective Gating Off /locking of Certain Service Description

See FIG. 2. The WTRU may have a PDU Session established with the 5GS, to be able to exchange user plane traffic with the Application server.

In step 201, an application function sends a request to the 5GS to reserve resources for an AF session. The request may include a service description. The service description may describe a traffic flow and be one or more IP 4-tuples. The service description may indicate a type of traffic flow. For example, a service description may indicate that the traffic of a web browsing type. For example, the request is an Nnef_AFsessionWithQos_Create, and may have any of the following request parameters/attributes: WTRU_identifier, DNN/S-NSSAI, service description, and indication related to energy cost criteria.

The service description may also include a combination of DNN/S-NSSAI, an application ID, or AF service identifier.

The AF may include an indication related to the energy cost of the traffic.

The AF may indicate that the energy cost for the user plane traffic related to the application needs to be minimized. The AF may further include threshold values for the energy cost that should not be exceeded. For example, the AF may include a maximum energy consumption threshold or a minimum energy efficiency threshold.

The AF may indicate that traffic gating is permissible/preferred for the service description provided by the AF for the AF session. The AF may indicate that traffic gating is permissible or preferred for the service description of interest, when an energy cost related criteria is met.

For example, the AF may indicate that the application traffic may be gated off if the user plane energy consumption related to the traffic, is very high.

In step 202, the NEF authorizes the AF request and forwards the request to the PCF.

The NEF may invoke the PCF API Npcf_PolicyAuthorization_Create (a request for creation of an application session context/a request to reserve resources for an application session). The NEF may include a WTRU identifier, DNN/S-NSSAI values, if received from the AF.

Then, the PCF authorizes the request and determines the PDU Session ID, for example from the DNN/S-NSSAI values.

The PCF uses the indication provided by the AF related to application traffic energy cost optimization, and potentially information related to the WTRU, to determine that traffic flow can be considered for gating and to obtain energy related information from the EECF network function.

In 203a, the PCF sends a message to the EECF to obtain energy cost related information. The PCF may include the type of information that needs to be obtained. For example, the PCF indicates that it wants an estimate of the energy consumption that the traffic flows of interest will incur in a certain time period. The request/subscribe 203a to energy cost information related to data traffic may include any of the following parameters: PDU session ID, service description, and energy cost attributes.

The PCF may request to obtain the energy consumption and energy efficiency related to the PDU Session that would be used to carry the application traffic.

Furthermore, the PCF may request the energy efficiency or average energy consumption of the network slice (using the DNN/S-NSSAI combinations) that will host the application traffic.

The PCF may request information about statistical energy usage of traffic having the same service type (e.g., web browsing or video streaming) as the traffic of interest.

The PCF may additionally determine to obtain information related to service experience for the application traffic of interest. For example, the PCF may send a message to the NWDAF to obtain estimates, statistics or predictions related to the service experience (e.g., observed service experience analytics) of the traffic of interest, in case the gating is activated or deactivated, and using different gating durations.

In step 203b, the EECF determines the energy cost information that was requested by the PCF.

In step 203c, the EECF sends the determined energy cost information to the PCF (sends info related to energy cost).

In step 204a, the PCF uses the energy cost result obtained from the EECF, and energy cost related criteria received from the AF, to determine the list of traffic flows to be blocked or gated off (PCF determines list of traffic flows/services to be blocked based on energy cost value and energy related criteria).

The PCF may determine that a traffic flow is to be blocked, if the estimated energy consumption of the traffic flow in a certain time period exceeds an acceptable threshold value.

The PCF may determine to block a certain traffic flow from being forwarded by the UPF, if the PDU Session current energy consumption value is above a certain threshold value.

A traffic flow may be determined to be gated off if the projected PDU Session energy consumption would exceed a certain threshold, if the traffic is not gated off.

The PCF may determine one or more traffic flows that need to be gated off based on the received energy cost result from the EECF. The PCF may determine a group of traffic flows that should be gated off.

If the PCF has information about a priority level of a traffic flow for a certain WTRU or PDU Session related to the WTRU, then the PCF may use the priority level of the traffic flow together with the energy cost result to determine which traffic flows to gate off and which traffic flow to not block.

The PCF may determine certain parameters related to the gating off of the traffic flows of interest. For example, the PCF may determine a time duration value for blocking the traffic flow of interest.

The PCF may further use information obtained from the NWDAF related to service experience, to determine an optimal value of the gating duration. For example, the PCF may determine that gating off traffic for a period of 30 seconds would not impact service or user experience significantly, while it helps minimizing the average energy consumption related to the PDU Session.

The PCF may determine time value for the minimum time between two consecutive gating activations.

For example, the PCF may determine that a period of 1 minutes needs to be considered in order to start a following traffic blocking operation, after a previous traffic blocking operation starts or completes.

These time values can be used by the UPF to determine how long to perform the traffic blocking, and when to resume traffic forwarding of the traffic flow of interest, and so on.

The PCF may determine to assess whether a certain traffic flow or service that is carried in the PDU Session, needs to be blocked, based on the energy cost related to the traffic flow (e.g., the average energy consumption that the traffic flow will incur in a certain time period is above a certain level).

The PCF may determine to assess whether certain traffic flows that are carried within a PDU Session, need to be blocked, based on an energy cost related to the group of traffic flows, or the PDU Session.

For example, the PCF may determine, based on information from the AF, to block one or more traffic flows related to the AF session, depending on the contribution of each traffic flow to the energy cost of the PDU Session or the group of traffic flows. The AF may have provided a threshold value related to the AF session or to a group of traffic flows. The AF may have provided different weights or priority level for each traffic flow, that can be used to determine how to optimize the gating of the traffic flows and optimization of the energy cost.

The PCF may determine that a notification to the AF regarding the gating status for the traffic flow of interest, is needed. The PCF may determine to send such a notification to the AF or instruct the SMF or UPF to send such as notification.

Before the PCF determines to gate the traffic off in this step, the PCF may first check if there is a way to reduce the power consumption that is associated with the traffic flow. For example, the PCF may decide to change the PCC Rules that are associated with the flow so that the flow receives a lower level of QoS treatment. For example, the PCF may decide to change UPF that anchors the PDU Session such that the traffic flow will consume less energy. If the PCF receives a notification that the energy cost for the traffic flow exceeds a threshold, the PCF may determine to gate the traffic flow off only if the PCF determines that the energy cost cannot be reduced by changing the QoS treatment of the flow or changing the UPF that anchors the flow.

In step 204b, the PCF generates the PCC rules related to the traffic flows of interest and includes gating configuration that was determined in step 204a (PCF generates/updates PCC rules with gate status set to “closed” for traffic flows to be blocked).

In a first embodiment, the PCC rule for the traffic flow of interest may include a gating status with the value set as determined in step 204a. For example, for traffic flow1, the PCC rule ID1 indicates the gate status to “open” and for traffic flow2, the PCC rule ID2 indicates the gate status to “closed”.

The PCF may determine to configure the UPF to switch between activating and deactivating the traffic blocking or gating for the traffic of interest, based on instruction from a NF such as the SMF.

For example, the PCF may determine two PCC rules for the traffic flow of interest. In a first PCC rule, the gating parameter is set to inactive or “open”. In a second PCC rule, the gating parameter is set to active or “closed”. The PCF may indicate that the two PCC rules are associated in terms of QoS enforcement or gating status. The SMF may use the two PCC rules to generate two packet detection rules for the same traffic flow description, where a first PDR has a QER with gate status “open” or gating inactive, and a second PDR has a QER with gate status set to “closed” or gating active. The two PDRs may be associated. Later, the SMF may send a message to the UPF to request the UPF to block some traffic or close the gate. The SMF may include the Rule ID of the PDRs of interest and can further indicate a gating status (e.g. “close”). The UPF then uses the Rule ID provided by the SMF to determine which pair of PDRs are of interest. The UPF may then use the parameter gating status provided by in the message from the SMF, to select the PDR that has the matching gating status, to be activated.

Alternatively, the SMF may determine two QoS enforcement rules that are associated, for the packet detection of interest. One QER has gating status set to “open”, and the second QER has the gating status set to “closed”. Later, when the SMF sends a message to the UPF to close the gate or block traffic for the traffic of interest, the UPF will determine to use the QER matching the gating status (in this example, gate is closed), for the PDR of interest. The PCF may include parameters related to gating such as a time duration for the gating off.

In step 204c, the PCF sends the generated PCC rules to the SMF.

The SMF uses the obtained PCC rules to generate N4 rules, and QoS rules.

The SMF generates N4 rules, for example Packet detection rules, which include a traffic or service descriptor, and one or more QoS enforcement rules.

The QoS enforcement rules includes a gating status that is set according to the PCC rule of the traffic of interest. For example, for traffic flow1, a PDR1 include traffic flow1 description, and a QER1 with gating status set to “open”. The SMF generates, for traffic flow2, a PDR2 that includes traffic flow2 description, and a QER2 that indicates a gating status of “closed”.

If the SMF was configured to be able to request the UPF to switch the gating status for the traffic flow of interest, the SMF may generate, for a certain traffic flow, two PDRs that are associated, one PDR that is set to active and has a QER that indicates the gating status is “open” and another PDR that is set to inactive, and that has a QER that indicate a gating status of “closed”.

Alternatively, the SMF may generate one PDR that includes two QERs that are associated, where one QER has a gating status set to “open” and the QER is set to active, and a second QER that has the gating status set to “closed” and which is set to inactive.

The SMF may include in the N4 rules time duration parameters to indicate the traffic blocking duration, and potentially the minimum time interval between two consecutive traffic blocking time periods.

The SMF also generates QoS rules for the WTRU.

The QoS rules include traffic flow descriptors to help identify the traffic flow of interest, and an instruction to mark the packets of the traffic flow with a certain QFI value.

Additionally, the QoS rules may indicate a gating status for the traffic flow of interest.

This gating status may allow the WTRU to block traffic in the UL direction when the gating status is set to “closed”. The QoS rule may also include parameters related to the traffic blocking duration and minimum time between two traffic blocking periods.

In step 205a, the SMF sends the generated N4 rules to the UPF (SMF sends N4 rules to UPF with gating set to “closed” for the selected traffic, and gating parameters).

In step 205b, the SMF sends the QoS rules to the WTRU (SMF sends a PDU session modification command comprising a list of services selected to be blocked).

In step 206, the application server and the WTRU exchange application traffic (User plane traffic exchange between WTRU and AS with selected traffic being blocked by WTRU and UPF).

For the uplink traffic, the WTRU may determine to block some traffic flows if the gating status in the corresponding QoS rules is set to “closed”. Similarly, the UPF may block traffic in the DL or UL direction, depending on the gating status included in the corresponding N4 rules.

The PCF may have subscribed to subscribe to energy cost related information to the EECF, and potentially service experience related information to the NWDAF.

Later, the PCF may receive a notification from the EECF that indicates that the estimated energy consumption of a certain traffic flow is below a certain threshold value. The PCF may then update the corresponding PCC rule with a gating status set to “open” (when it was set to “closed” previously).

Alternatively, the PCF may have instructed the SMF to request/subscribes to energy cost related information from the EECF, and potentially service experience related information to the NWDAF.

The EECF/PCF may consider WTRU battery level information for the decision to block certain traffic or not. For example, if WTRU battery level is below a threshold, EECF/PCF may block certain traffic for the WTRU with an estimated energy consumption above a threshold.

Later, the SMF may receive a notification from the EECF indicating that traffic flow2,which initially has an estimated energy consumption above threshold value Th2, now has an estimated energy consumption value that is below Th2. The SMF may use this indication to request that UPF deactivate traffic blocking for traffic flow2 or change the gating status to “open”.

### WTRU Configures the PCF With Energy Cost Criteria and PCF Determines Selective Gating Off /locking of Certain Service Description

In FIG. 2, the PCF receives a request message from the AF via the NEF that includes service description, and energy cost related criteria (e.g., an indication that the energy cost associated with the service should not exceed an indicated level). The PCF uses that message to request/subscribe to energy estimates from the EECF and determine whether the traffic flow of interest needs to be blocked. The PCF generates PCC rules with the determined gating status and configuration and sends the PCC rules to the SMF to configure the UPF and WTRU.

In another embodiment, see FIG. 3, the PCF may receive a request message 301 from the WTRU via NAS messaging and the SMF. The request message may include the PDU Session ID, service description, and energy cost related criteria (e.g., a NAS message with any of the following parameters/attributes: PDU session ID; indication of energy related criteria; and energy based traffic gating is ok (meaning an agreement of the WTRU to use traffic gating for the WTRU)). The PCF uses the information received from the WTRU via the SMF in 302 (SM Policy Association Establishment with parameters/attributes being any of: PDU session ID; service description; energy criteria indication; energy based traffic gating is ok (meaning an agreement of the WTRU to use traffic gating for the WTRU)) to be triggered to request/subscribe to energy estimates from the EECF. In this case, step 303a to 305b (and 306) may be performed, similar to steps 203a to 205b (and 206) of FIG. 2.

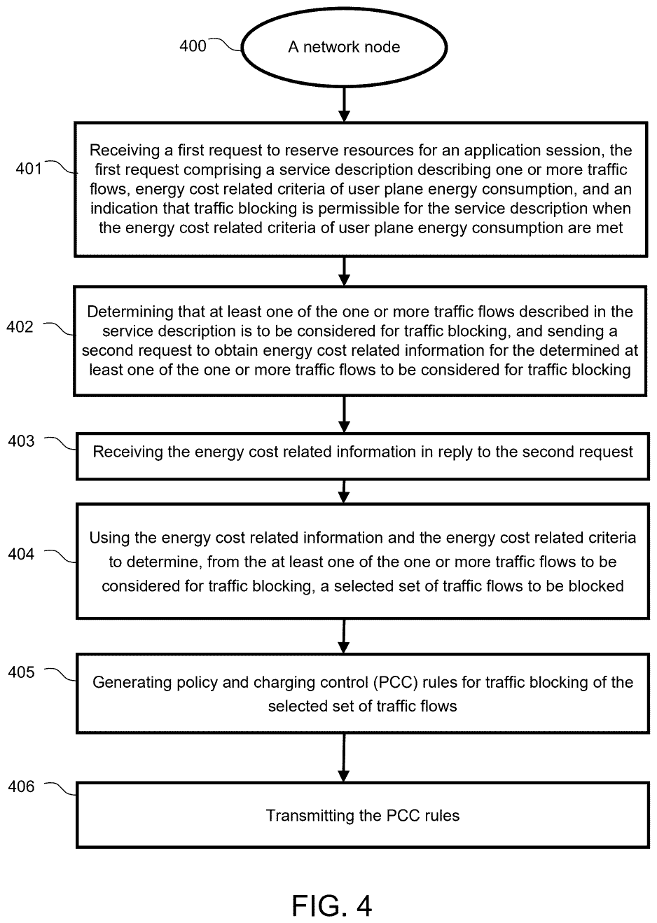

FIG. 4 is a method for user plane traffic gating based on energy cost according to an embodiment.

The method 400 may be implemented by a network node, such as a PCF. The method may comprise:
receiving (401), e.g., from the NEF, a first request to reserve resources for an application session (e.g., a Npcf_PolicyAuthorization_Create 202 (FIG. 2) or 302 (FIG. 3)), the first request comprising a service description describing one or more traffic flows, energy cost related criteria of user plane energy consumption, and an indication that traffic blocking is permissible for the service description when the energy cost related criteria of user plane energy consumption are met;
determining (402) (e.g., 203b (FIG. 2) or 303b (FIG. 3) ) that at least one of the one or more traffic flows described in the service description is to be considered for traffic blocking, and sending a second request (e.g., a request/subscribe to energy cost information 203a (FIG. 2) or 303a (FIG. 3) to the EECF), to obtain energy cost related information for the determined at least one of the one or more traffic flows to be considered for traffic blocking;
receiving (403) (e.g., 203c (FIG. 2) or 303c (FIG. 3) from the EECF) the energy cost related information in reply to the second request;
using (404) the energy cost related information and the energy cost related criteria to determine (e.g., 204a (FIG. 2) or 302a (FIG. 3), from the at least one of the one or more traffic flows to be considered for traffic blocking, a selected set of traffic flows to be blocked;
generating (405) (e.g., 204b (FIG. 2) or 304b (FIG. 3)) policy and charging control (PCC) rules for traffic blocking of the selected set of traffic flows; and
transmitting (406) (e.g., 204c (FIG. 2) or 304c (FIG. 3)) the PCC rules, e.g., to the SMF.

According to an embodiment, the first request comprises information (e.g., a DNN/S-NSSAI) allowing to determine a packet data unit (PDU) session identifier, and wherein the second request is for obtaining energy consumption and/or energy efficiency of application traffic carried by a PDU session identified by the PDU session identifier.

According to an embodiment, the first request comprises information related to a network slice (e.g., S-NSSAI) and wherein the first request comprises information allowing to determine a packet data unit (PDU) session identifier, and wherein the second request is for obtaining energy consumption and/or energy efficiency of a network slice hosting application traffic carried by a PDU session identified by the PDU session identifier.

According to an embodiment, the second request is for obtaining statistical information about energy usage of traffic having a same service type as a service type of the at least one of the one or more traffic flows to be considered for traffic blocking.

According to an embodiment, the energy cost related information comprises estimated energy consumption per traffic flow of the one or more traffic flows described in the service description, the network node using the energy cost related information and the energy cost related criteria to include, in the selected set of traffic flows to be blocked, traffic flows for which estimated energy consumption in a time period exceeds a threshold comprised in the energy cost related criteria.

According to an embodiment, the energy cost related information comprises estimated energy consumption per traffic flow of the one or more traffic flows described in the service description, the network node using the energy cost related information and the energy cost related criteria to include, in the selected set of traffic flows to be blocked, traffic flows for which estimated energy consumption in a time period exceeds a threshold comprised in the energy cost related criteria during a time period comprised in the energy cost related criteria.

According to an embodiment, the method comprises using the energy cost related information and the energy cost related criteria to determine a time duration for traffic blocking of at least one traffic flow of the selected set of traffic flows to be blocked.

According to an embodiment, the method comprises using the energy cost related information and the energy cost related criteria to determine a time interval between subsequent traffic blockings of at least one traffic flow of the selected set of traffic flows to be blocked.

There is also disclosed and described a network node (e.g., a PCF), comprising at least one processor configured to:
receive a first request to reserve resources for an application session, the first request comprising a service description describing one or more traffic flows, energy cost related criteria of user plane energy consumption, and an indication that traffic blocking is permissible for the service description when the energy cost related criteria of user plane energy consumption are met;
determine that at least one of the one or more traffic flows described in the service description is to be considered for traffic blocking, and send a second request to obtain energy cost related information for the determined at least one of the one or more traffic flows to be considered for traffic blocking;
receive the energy cost related information in reply to the second request;
use the energy cost related information and the energy cost related criteria to determine, from the at least one of the one or more traffic flows to be considered for traffic blocking, a selected set of traffic flows to be blocked;
generate policy and charging control (PCC) rules for traffic blocking of the selected set of traffic flows; and
transmit the PCC rules.

According to an embodiment of the network node, the first request comprises information allowing the at least one processor to determine a packet data unit (PDU) session identifier, and wherein the second request is for obtaining energy consumption and/or energy efficiency of application traffic carried by a PDU session identified by the PDU session identifier.

According to an embodiment of the network node, the first request comprises information related to a network slice and wherein the first request comprises information allowing to determine a packet data unit (PDU) session identifier, and wherein the second request is for obtaining energy consumption and/or energy efficiency of a network slice hosting application traffic carried by a PDU session identified by the PDU session identifier.

According to an embodiment of the network node, the second request is for obtaining statistical information about energy usage of traffic having a same service type as a service type of the at least one of the one or more traffic flows to be considered for traffic blocking.

According to an embodiment of the network node, the energy cost related information comprises estimated energy consumption per traffic flow of the one or more traffic flows described in the service description, the at least one processor being configured to use the energy cost related information and the energy cost related criteria to include, in the selected set of traffic flows to be blocked, traffic flows for which estimated energy consumption in a time period exceeds a threshold comprised in the energy cost related criteria.

According to an embodiment of the network node, the energy cost related information comprises estimated energy consumption per traffic flow of the one or more traffic flows described in the service description, the at least one processor being configured to use the energy cost related information and the energy cost related criteria to include, in the selected set of traffic flows to be blocked, traffic flows for which estimated energy consumption in a time period exceeds a threshold comprised in the energy cost related criteria during a time period comprised in the energy cost related criteria.

According to an embodiment of the network node, the at least one processor being configured to use the energy cost related information and the energy cost related criteria to determine a time duration for traffic blocking of at least one traffic flow of the selected set of traffic flows to be blocked.

According to an embodiment of the network node, the at least one processor being configured to use the energy cost related information and the energy cost related criteria to determine a time interval between subsequent traffic blockings of at least one traffic flow of the selected set of traffic flows to be blocked.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method, implemented by a network node, comprising:
receiving a first request to reserve resources for an application session, the first request comprising a service description describing one or more traffic flows, one or more energy cost related criteria of user plane energy consumption, and an indication that traffic blocking is permissible for the service description when the one or more energy cost related criteria of user plane energy consumption are met;
determining that at least one of the one or more traffic flows described in the service description is to be considered for traffic blocking, and sending a second request to obtain energy cost related information for the determined at least one of the one or more traffic flows to be considered for traffic blocking;
receiving the energy cost related information in reply to the second request;
using the energy cost related information and the one or more energy cost related criteria to determine, from the at least one of the one or more traffic flows to be considered for traffic blocking, a selected set of traffic flows to be blocked;
generating one or more policy and charging control (PCC) rules for traffic blocking of the selected set of traffic flows; and
transmitting the one or more PCC rules.

2. The method of claim 1, wherein the first request comprises information allowing to determine a packet data unit (PDU) session identifier, and wherein the second request is for obtaining energy consumption and/or energy efficiency of application traffic carried by a PDU session identified by the PDU session identifier.

3. The method of claim 1, wherein the first request comprises information related to a network slice and wherein the first request comprises information allowing to determine a packet data unit (PDU) session identifier, and wherein the second request is for obtaining energy consumption and/or energy efficiency of a network slice hosting application traffic carried by a PDU session identified by the PDU session identifier.

4. The method of claim 1, wherein the second request is for obtaining statistical information about energy usage of traffic having a same service type as a service type of the at least one of the one or more traffic flows to be considered for traffic blocking.

5. The method of claim 1, wherein the energy cost related information comprises estimated energy consumption per traffic flow of the one or more traffic flows described in the service description, the network node using the energy cost related information and the one or more energy cost related criteria to include, in the selected set of traffic flows to be blocked, traffic flows for which estimated energy consumption in a time period exceeds a threshold comprised in the energy cost related criteria.

6. The method of claim 1, wherein the energy cost related information comprises estimated energy consumption per traffic flow of the one or more traffic flows described in the service description, the network node using the energy cost related information and the one or more energy cost related criteria to include, in the selected set of traffic flows to be blocked, traffic flows for which estimated energy consumption in a time period exceeds a threshold comprised in the one or more energy cost related criteria during a time period comprised in the energy cost related criteria.

7. The method of claim 1, comprising using the energy cost related information and the one or more energy cost related criteria to determine a time duration for traffic blocking of at least one traffic flow of the selected set of traffic flows to be blocked.

8. The method of claim 7, comprising using the energy cost related information and the one or more energy cost related criteria to determine a time interval between subsequent traffic blockings of at least one traffic flow of the selected set of traffic flows to be blocked.

9. A network node, comprising at least one processor configured to:
receive a first request to reserve resources for an application session, the first request comprising a service description describing one or more traffic flows, one or more energy cost related criteria of user plane energy consumption, and an indication that traffic blocking is permissible for the service description when the one or more energy cost related criteria of user plane energy consumption are met;
determine that at least one of the one or more traffic flows described in the service description is to be considered for traffic blocking, and send a second request to obtain energy cost related information for the determined at least one of the one or more traffic flows to be considered for traffic blocking;
receive the energy cost related information in reply to the second request;
use the energy cost related information and the one or more energy cost related criteria to determine, from the at least one of the one or more traffic flows to be considered for traffic blocking, a selected set of traffic flows to be blocked;
generate one or more policy and charging control (PCC) rules for traffic blocking of the selected set of traffic flows; and
transmit the one or more PCC rules.

10. The network node of claim 9, wherein the first request comprises information allowing the at least one processor to determine a packet data unit (PDU) session identifier, and wherein the second request is for obtaining energy consumption and/or energy efficiency of application traffic carried by a PDU session identified by the PDU session identifier.

11. The network node of claim 9, wherein the first request comprises information related to a network slice and wherein the first request comprises information allowing the at least one processor to determine a packet data unit (PDU) session identifier, and wherein the second request is for obtaining energy consumption and/or energy efficiency of a network slice hosting application traffic carried by a PDU session identified by the PDU session identifier.

12. The network node of claim 9, wherein the second request is for obtaining statistical information about energy usage of traffic having a same service type as a service type of the at least one of the one or more traffic flows to be considered for traffic blocking.

13. The network node of claim 9, wherein the energy cost related information comprises estimated energy consumption per traffic flow of the one or more traffic flows described in the service description, the at least one processor being configured to use the energy cost related information and the one or more energy cost related criteria to include, in the selected set of traffic flows to be blocked, traffic flows for which estimated energy consumption in a time period exceeds a threshold comprised in the energy cost related criteria.

14. The network node of claim 9, wherein the energy cost related information comprises estimated energy consumption per traffic flow of the one or more traffic flows described in the service description, the at least one processor being configured to use the energy cost related information and the one or more energy cost related criteria to include, in the selected set of traffic flows to be blocked, traffic flows for which estimated energy consumption in a time period exceeds a threshold comprised in the one or more energy cost related criteria during a time period comprised in the energy cost related criteria.

15. The network node of claim 9, the at least one processor being configured to use the energy cost related information and the one or more energy cost related criteria to determine a time duration for traffic blocking of at least one traffic flow of the selected set of traffic flows to be blocked.

16. The network node of claim 15, the at least one processor being configured to use the energy cost related information and the one or more energy cost related criteria to determine a time interval between subsequent traffic blockings of at least one traffic flow of the selected set of traffic flows to be blocked.
